(19) United States
(12) Patent Application Publication
(10) Pub. No.: US 2009/0164340 A1
(43) Pub. Date: Jun. 25, 2009

(54) SYSTEM AND METHOD FOR POPULATING A GIFT REGISTRY USING UPLOADED PRODUCT INFORMATION

(75) Inventor: Alex A. Lluch, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Alex A. Lluch, San Diego, CA (US)

(21) Appl. No.: 12/244,205

(22) Filed: Oct. 2, 2008

Related U.S. Application Data
(60) Provisional application No. 61/016,185, filed on Dec. 21, 2007.

(51) Int. Cl. G06Q 30/00; G06F 7/06; G06F 17/30

(52) U.S. Cl. 705/27; 705/26; 707/3; 707/E17.019; 707/E17.014

(57) ABSTRACT

According to one embodiment of the invention, a method comprises recovering a product identifier downloaded from portable electronic device, and thereafter, searching a database by the portable electronic device. This search uses a product identifier to uncover any occurrences of the product associated with the product identifier in a database containing multiple products from multiples retailers. Thereafter, a message including a name of one or more merchants selling the product or an item equivalent to the product, and a price of the product or the item equivalent to the product is returned.

This application claims the benefit of priority of U.S. Provisional Patent Application No. 61/016,185, filed Dec. 21, 2007, the contents of which are incorporated by reference.

### FIELD

Embodiments of the invention generally relate to a system and method for formulating and updating registries based on uploaded product information. More specifically, embodiments of this invention relate to a configurable gift registry.

### GENERAL BACKGROUND

Gift registries are created for momentous occasions, such as baby and wedding showers, anniversary parties or the like. Currently, there are two types of registries: merchant-based registries and on-line registries.

For merchant-based registries, a registrant physically visits the merchant's store and obtains an optical bar code reader. Thereafter, the registrant walks through the store and upon locating a desired product or service to add to her registry, she scans a barcode (e.g., UPC) that identifies the product or service. These merchant-based registries suffer from a number of disadvantages.

For instance, for this type of registry, a registrant is only able to register those products available at the merchant's store. Hence, the merchant-based registry does not take into account purchases made at other stores. Such purchases may have been prompted by discounts (e.g., coupons, employee discounts, etc.) that were not offered at merchant's store.

For on-line registries, the registrant visits the merchant's website and selects products from that merchant and adds the gifts to his/her registry. For this registration, the following operations are performed:
(1) the registrant establishes communications with the merchant's web server over the Internet;
(2) the registrant selects products and/or services from that merchant only;
(3) the registrant creates an account with that merchant's website;
(4) the registrant adds the products and/or services to his/her registry; and
(5) the registrant notifies her friends and family know that she created a registry with that merchant; and thereafter,
(6) friends and family can now login to the registrant's account on that merchant's website and can only buy a gift for this user from that merchant's website.

The disadvantages associated with on-line registries are that the registrant is not able to physically review the products/services prior to registration. Therefore, in certain situations, purchased products received by the registrant may not meet the registrant's expectations.

Another disadvantage is that the registrant is limited to registering for gifts from one single website. If the user registers for gifts from more than one online registry, the user would need to notify his/her guests of all the website addresses (Uniform Resource Locators “URLs”) where he/she has created a registry.

### BRIEF DESCRIPTION OF THE DRAWINGS

Features and advantages of embodiments of the invention will become apparent from the following detailed description in which:

FIG. 1 is an exemplary embodiment of a network employing one or more web servers dedicated for maintaining gift registries.

FIGS. 2A and 2B are illustrative embodiments of a web server.

FIG. 3 is an illustrative embodiment of an input device for capturing the product information to be uploaded to the web server of FIG. 2.

FIG. 4 is a first illustrative embodiment of operations performed by the web server in analyzing the desired good/service and downloading a selected good/services for placement onto the gift registry.

FIG. 5 is a second illustrative embodiment of operations performed by the web server in analyzing the desired good/service and downloading a selected good/services for placement onto the gift registry.

FIG. 6 is a third illustrative embodiment of operations performed by the web server in analyzing the desired good/service and downloading a selected good/services for placement onto the gift registry.

FIG. 7 is an illustrative flowchart outlining the operations performed in updating the registry based on capturing a UPC code or other product identifier.

### DETAILED DESCRIPTION

Embodiments of the invention set forth in the following detailed description generally relate to a system and method for formulating and updating an electronic listing, such as a gift registry. The gift registry is updated with information concerning goods and/or services that are to be listed (hereinafter such goods and/or services generally referred to as “products”).

Herein, the system allows the user to add/update products to one centralized online gift registry from any website or physical store. Using available Short Message Service (SMS) technology or wireless email, the user can send a message with a product identifier to a predetermined phone or SMS number or a predetermined email address, respectively. Alternatively, Wireless Application Protocol (WAP) may be used for communications with the registry system. Examples of a “product identifier” include, but are not limited or restricted to any of the following: (1) a picture of the barcode on the desired product, (2) the Universal Product Code (UPC) number for the desired product, (3) a brand name/model number of the desired product, etc.

Computational code, specifically designed for this purpose, is stored within the system and processed to transform the product identifier sent by the user into usable data that the system can process to search in a product database to find out any occurrences of the requested product. If the product is in fact available in the product database, the system will find all the occurrences of the product and prepare a Response message for return to the user. The “Response message” may include, but is not limited or restricted to a text, voice or electronic mail message that includes, inter alia, the name of one or more merchants selling the product (or an equivalent product), product description, price, etc.

The user, still shopping around, will get a formatted Response message. If the product is available from one or multiple merchants in the registry system database, the user will be able to selectively add the product to his/her account from one or more of the available merchants, or cancel the request.

The system will process the user's answer to either add the selected product(s) to his/her online registry or cancel any further action. In any case, the system will send a confirmation/acknowledgement message back to the user. If the product is added, a consumer visiting the user's online gift registry in order to purchase a product for the user will find the new addition to the user's gift list.

In the following description, certain terminology is used to describe certain features of one or more embodiments of the invention. For instance, an “electronic device” is defined as an electronic product with an input device to capture or enter product information. In this detailed description, for clarity sake, the electronic device is illustrated as a portable cellular telephone with a built-in camera according to one embodiment. However, it is evident that the invention may be utilized in other types of electronic devices including, but not limited or restricted to personal digital assistants, hand-held computers, digital cameras, pagers, or the like. In addition, the electronic device could be any cellular phone, Wireless Application Protocol (WAP), or PDA with text message or e-mail capabilities used to send a product's identifier to the registry service.

‘Software’ is generally defined as one or more instructions that, when executed by a processor (e.g., microprocessor, application specific integrated circuit “ASIC”, microcontroller, programmable gate array, etc.) implemented within an electronic device, to perform a particular function or functions. These instructions may be stored within machine-readable medium such as firmware or software. “Machine-readable medium” is any medium that can at least temporarily store information including, but not limited or restricted to the following: an electronic circuit, a semiconductor memory device (non-volatile or volatile), a hard disk drive, and various types of portable storage devices (e.g., flash drive, compact disc “CD”, digital versatile disk “DVD”, etc.).

The term “interconnect” is any medium that is capable of transferring signals from one point to another. Examples of an interconnect may include one or more electrical wires, a cable (e.g., Ethernet cable, optical fiber, etc.), air supporting the transmission between wireless transmitter/receiver, or any combination thereof.

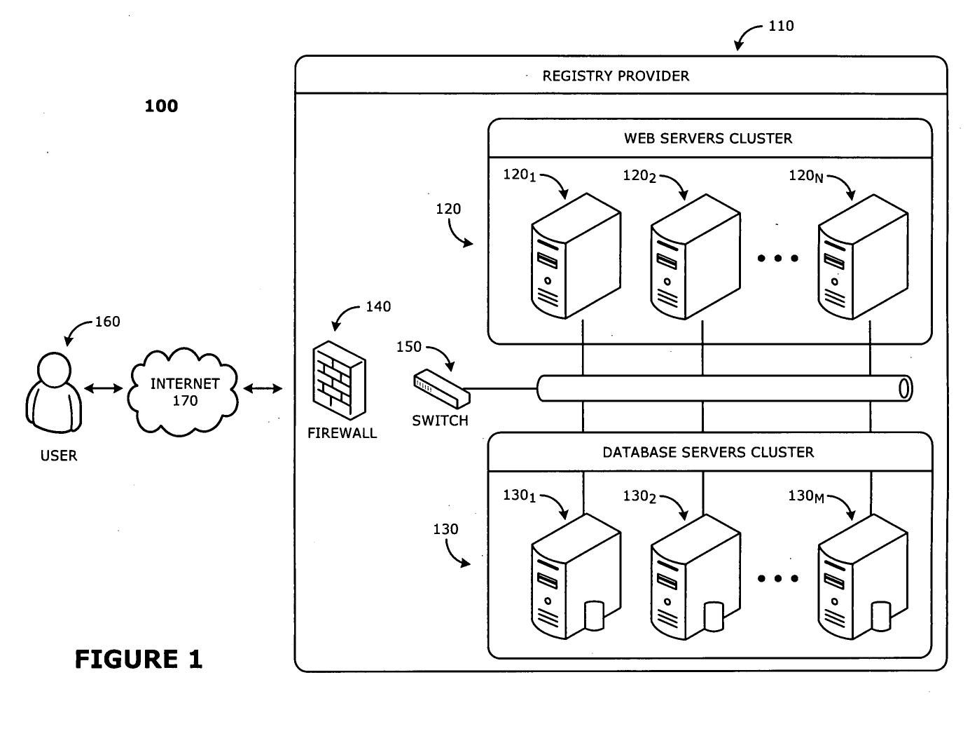

Referring to FIG. 1, an exemplary embodiment of a network 100 supporting an on-line registry system 110 is shown. Registry system 110 comprises a cluster (group) of servers working in tandem for maintaining online gift registries. In particular, a web server cluster 120 features a group of web servers 120₁-120_{N} (N≧1) and a database server cluster 130. Sometimes referred to as a “products database,” database server cluster 130 comprises a group of database servers 130₁-130_{M} (M≧1) that operate to modify and update an online registry. Of course, it is contemplated that a single server or a single set of servers may be adapted to handle the functionality supported by web servers 120₁-120_{N} and database servers 130₁-130_{M}.

Herein, one or more web servers 120₁-120_{N} are configured to host specialized software components that can interpret users' requests and perform the requisite action or provide the requisite content. For instance, in response to a PRODUCT REGISTRATION message by a user 160 via Internet 170, the software components) can extract information concerning the product(s) identified in the PRODUCT REGISTRATION message. This information is compared with contents listed in a current online registry for the user, which is stored within one or more database servers 130₁-130_{M}. Database servers 130₁-130_{M} maintain all the data pertinent to the online gift registry including, but not limited or restricted to the products available to the gift registry and registry users' preferences.

As optional components, registry system 110 may be implemented with a fireball 140 to protect the stored information and system integrity. Moreover, one or more switches 150 may be adapted to distribute the requests received over network 100 in the event that registry system 110 includes multiple servers and different clusters of servers.

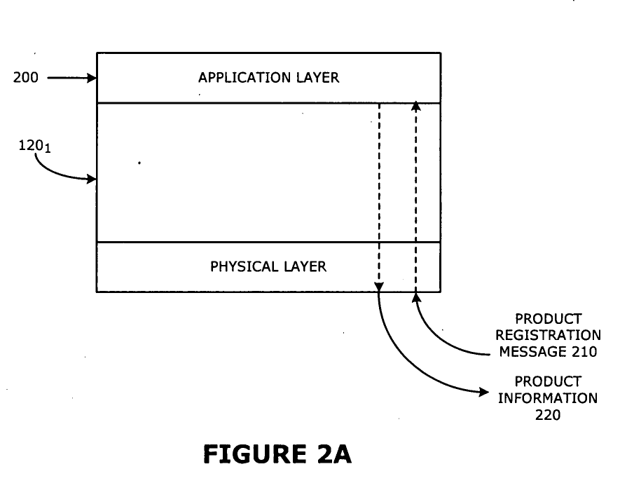

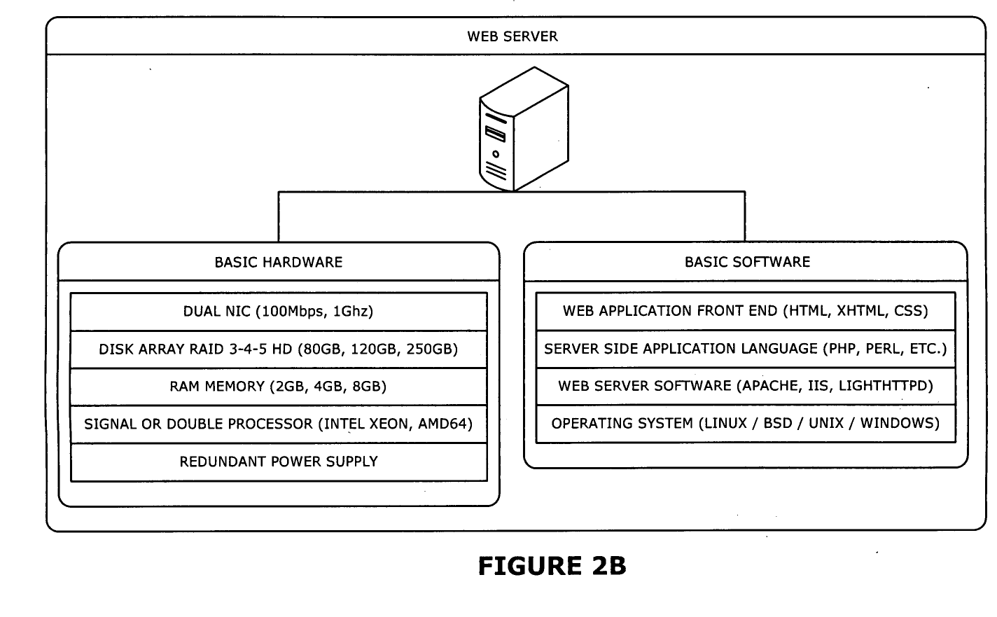

Referring now to FIG. 2A, an exemplary embodiment of configuration for web server 120₁ of FIG. 1 is shown. In accordance with the Open System Interconnect (OSI) layout, web server 120₁ features software loaded at the Application Layer 200 that is configured to detect a PRODUCT REGISTRATION message 210 and to extract product information 220 for storage within web server 120₁. For instance, a picture of the UPC bar code concerning a product to be registered may be placed within PRODUCT REGISTRATION message 210 and subsequently extracted by the software responsible for identifying that message. The specifics for the hardware and software of web server 120₁ are shown in FIG. 25.

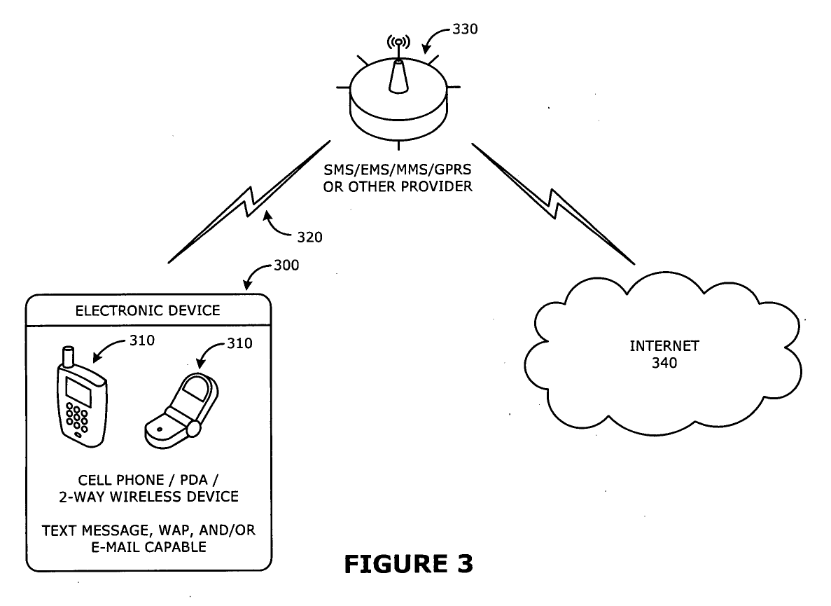

Referring to FIG. 3, an illustrative embodiment of an electronic device 300 for capturing product information 220 to be uploaded to web server 120₁ of FIG. 2 is shown. More specifically, electronic device 300 is adapted to support Short Message Service (SMS) communications and/or electronic mail (email) communications. Examples of various forms of electronic device 300 may include, but are not limited or restricted to a cellular telephone, a personal digital assistant “PDA”, 2-way wireless device, Wireless Application Protocol (WAP), an alpha-numeric pager, a barcode scanner, a portable computer, or the like.

As shown, electronic device 300 features an input unit 310 to allow the user to gather product information for transmission over a communication pathway 320 supporting SMS messaging or email messages. For instance, input unit 310 may be implemented as a keypad or touch pad to allow the user to enter product information such as a UPC barcode or an alphanumeric description of the product. According to another embodiment, input unit 310 may be implemented as a camera unit for capturing an image for transmission to registry system 110 of FIG. 1.

As shown, electronic device 300 downloads the product information to a wireless provider 330, which operates as a gateway for the user to connect to a network 340 (e.g., a public network such as the Internet). Over network 340, the product information is routed to database server cluster 130 of FIG. 1, which features multiple on-line gift registry servers.

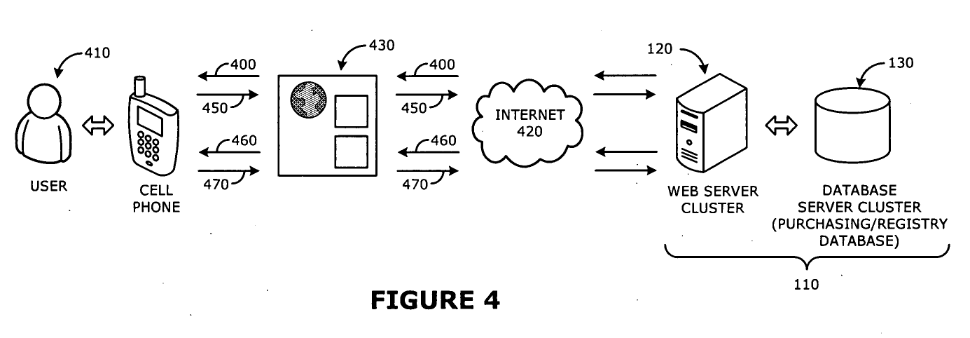

Referring to FIG. 4, a first illustrative embodiment of operations performed by software executed on web server 120₁ in analyzing a product to be registered and placed into database server cluster 130 of registry system 110 is shown. Herein, a basic configuration for the networked registry system and its components is shown, where the arrows detail the direction of the flow of information.

Initially, according to this embodiment of the invention, the user sends a request 400 to registry system 110 using his/her electronic device 300 (e.g., cellular telephone). This request, referred to as a “Lookup Request message 400,” is adapted to look for a specific product in database server cluster 130. Through a public-accessible network 420, Lookup Request message 400 is directed to a web server (e.g., web server 120₁) of web server cluster 120 via any means such as an SMS Web Interface 430 or via Wireless Application Protocol. SMS web service 430 receives the wireless signal and transfers the information to public-accessible network 420 such as the Internet 420. Based on Lookup Request message 400, web server 120₁ performs lookup operations for content within database service cluster 130 and sends a Response message 450 back to a requesting user 410 with the appropriate information that will allow user 410 to make a decision. Response message 450 from registry system 110 will include, but is not limited or restricted to information such as the product identifier or any other product identifying code, product description, model number, store or website who carries the product, price, available attributes, etc. Respond message 450 may further, or alternatively, include a message saying that the product is not available, or it may include multiple instances of the same or similar products as the one the user is searching for.

After revising his/her options, user 410 sends back to registry system 110 a choice selection message 460 that identifies the choices he/she would like to make. This choice selection message 460 may include a code, word or group of letters such as “Add,” that will advise registry system 110 what action to take with the next incoming message. The user's choice may also include, but is not limited or restricted to the product identifier, the amount of units the user would like to register for, and any product attributes such as size, color, pattern, etc. Registry system 110 will process the user's choices accordingly and will send a confirmation message 470 back to user 410 closing the flow of information through the system.

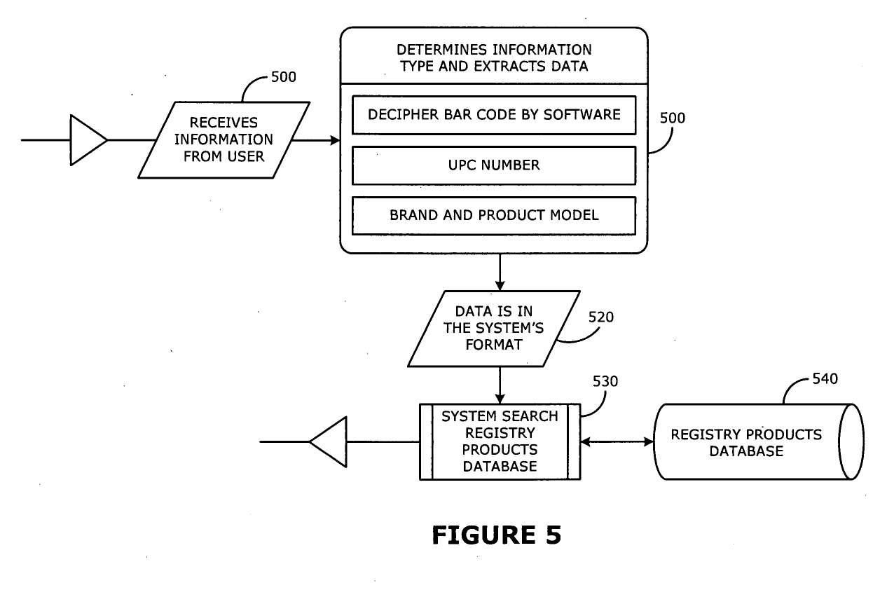

Referring now to FIG. 5, a second illustrative embodiment of operations (e.g., software-based operations) performed by web server 120₁ in analyzing the desired product and downloading a selected product for placement onto a gift registry is shown. Herein, the processing of requests based on the product identification sent by the user is highlighted.

This process is performed by specialized software developed to extract the searching data from the information sent by the user (see blocks 500 and 510). The searching data may include product identifier that may exist in many forms (i.e. Brand and Model, UPC number, Bar Code image, etc.). If necessary, the searching data is placed into a format recognized by the database servers forming the product database (block 520). Thereafter, the registry system will use the searching data as parameters to search the products database in order to determine if the desired product is available among the items carried by the online gift registry service and it will respond to the user accordingly (blocks 530 and 540).

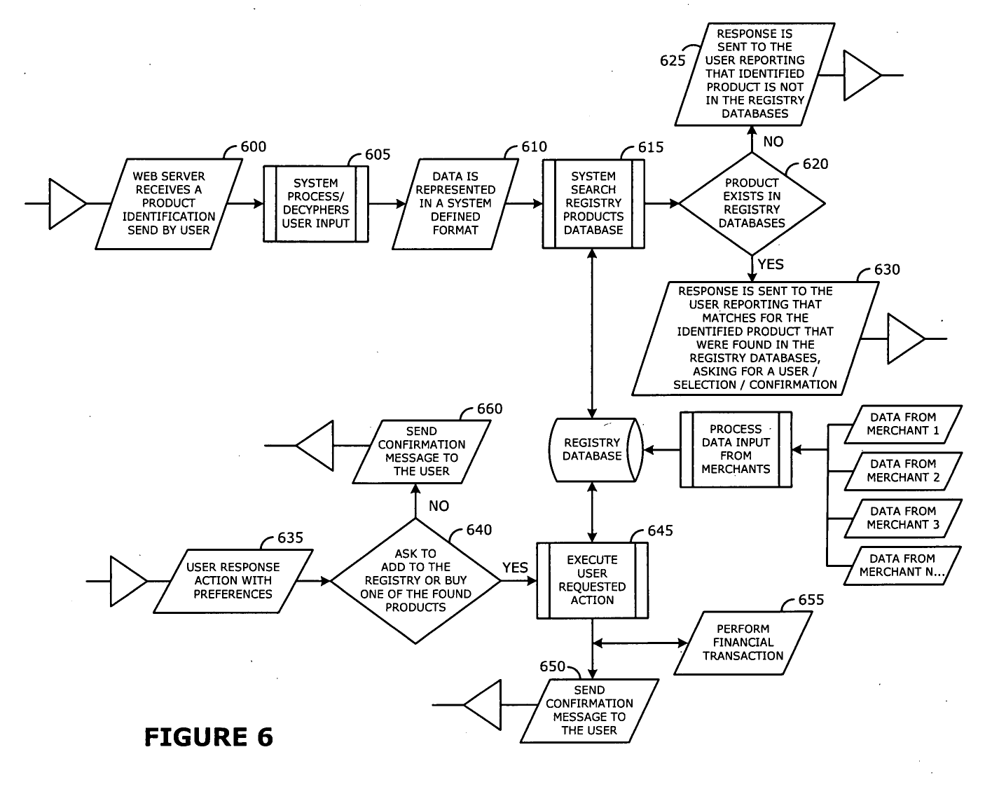

Referring now to FIG. 6, an illustrative embodiment of operations performed by the web server of the registry system in analyzing the desired good/service and downloading a selected product for placement onto the gift registry is shown. This figure further describes the process in the web server to serve the user requests.

As described, the process at the web server starts with a request from a user, where the request provides the product identifier belonging to an item he/she would like to add to his/her registry (block 600). The registry system will proceed to decipher the request to extract pertinent data that will allow for a search in the product databases to be conducted (block 605). Once the information is represented in a system readable format, the search against the online gift registry's product database begins (blocks 610 and 615). As a result of the search process, the registry system will determine if the requested product exists in the system's database (block 620). If the product does not exist, a message to that extent will be sent back to the user (block 625) to allow the user to upload the product information. If the product does exist (it could have more than one occurrence by different merchants) the system will send back to the user a message with relevant information such as, for example, merchant, product description, price, and a product identifier per occurrence (block 630).

Herein, the “product identifier” is a code represented by a series of alphanumeric characters that the user will use to send information via a text message, e-mail, etc.) back to the registry service indicating which product and from which merchant the user wants to add to his/her registry.

According to this embodiment of the invention, the user indicates what action he/she wants the registry system to take (block 635). Using the product identifier or any other identifier, the user would respond by selecting the product to be added to his/her online gift registry (block 640 and 645). For instance, if the request is for the addition of a product to be added to the registry, information identifying the product (e.g., product identifier, description, etc.) is uploaded to databases of the registry system and the number of available products as maintained by the database servers. A confirmation message is returned to the user (block 650).

As another illustrative example, users may use this system while shopping at a store to compare products and prices and to purchase the product for themselves. For example, if the user is interested in purchasing a product found in the registry system, the user can add it to the registry, and at a later time, visit the registry system from any computer, login to his/her account and purchase the product from the registry.

Moreover, this system could be also used to purchase a product directly from the phone. In this case, a request is directed to purchasing a product, the product identifier is checked (blocks 640 and 645). If there is a match for the product (and the number of products selected are still available for purchase), the transaction proceeds by verification of a financial data and processes the transaction before confirmation of the purchase (block 655).

In addition, if the user wants to select product attributes (e.g., color, size, etc.), the user will send the proper product attribute to the system for inclusion on his/her registry. There will be a specific format that the user will follow to send this information to the registry service.

For example, according to one embodiment of the invention, the registry system may be designed to expect the user to send the product identifier followed by a comma follow by the number of units that the user would like to register for, follow by a comma and follow by one or more (“t”) product attributes as shown in Table 1 below.

TABLE 1

<product identifier, #units, attribute_1,...,
attribute_t>

Again, the product identifier will provide information to the registry system as to which product and from which merchant the user wishes to select. The information that follows after the second comma is the product attributes that will be made available to the user's guests when they are ready to purchase the gift.

Again, a word such as “add” may or may not be used by the user to tell the system to add the product.

If the user creates a message that doesn't follow the correct format (e.g., the user puts “red” after the first comma, or the number “1” after the second comma for the illustrated embodiment), the system may try to guess what the user intended to do or may immediately send a message advising the user that the message is invalid with a prompt as to the intended format.

On the other hand, if the user does not wish to add the selected product to his/her registry, the user could send a cancellation of the request by sending a specific code that signals the registry system that the user do not want to choose any of the available options (see block 660). This code can be composed of a series of numbers and/or letters. If the user does not answer, the registry system will expire the request after some predetermined period of time.

In the case of the user sending an answer back, the system will act accordingly. If the answer contains the product identifier or any other “answer identifier”, the registry system will use that identification to add the selected choice to the user's online gift registry. If the answer is a cancellation, the system will delete the specific request from the queue. In both cases, the system will send a confirmation message back to the user acknowledging the end of the query.

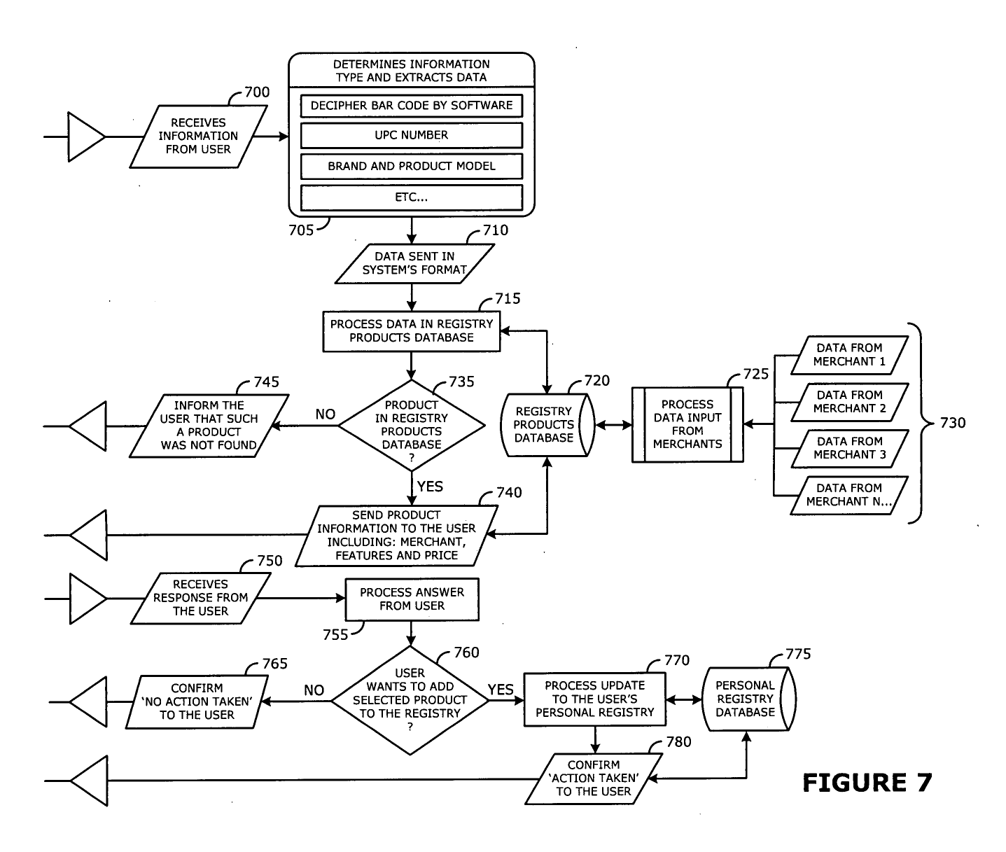

Referring now to FIG. 7, an illustrative flowchart outlining the operations (e.g., software-based operations) performed in updating the registry based on capturing a UPC code or other product identifier is shown. Herein, this figure describes in more detail the process on the web server side to serve the user request.

After receiving information from the user, the registry system will use specialized codes to extract the data to process the request (blocks 700 and 705). After putting the data in the system defined format (block 710), the system will look into the product database to search or the occurrences of the requested product(s) (blocks 715 and 720). The product(s) could be provided by many different merchants at equal or different prices (blocks 725 and 730). After searching the product database and determining if there are or are not any occurrences of the requested product, the registry system will send a response to the requester with either a list of the products found by merchants, including a product identifier or any other code for identification purposes (blocks 735 and 740), or a message informing the user that no occurrence of the requested item is available at the present time in the database (blocks 735 and 745). The system will keep a record of every particular request in order to continue processing the user requests.

After receiving a response from the registry system, the user must make a choice and select a product, identified by an identifier code or any other identifier, along with number of products to be added and its attributes or cancel the requesting query (blocks 750, 755, 760 and 765). Once the decision has been made, the user sends a new message to the registry system with the action required regarding his/her request.

After receiving the selection made by the user, the system will proceed accordingly. If the user chooses to add a specific occurrence of the requested item to his/her registry, the system will process such request updating the records in the user's personal registry database to reflect the new item added to the user's registry and confirm to the user that the new product has been added (blocks 770, 775 and 780). If the selection was to cancel the request/transaction or no answer is received by the system in a pre-defined period of time, a new message will be sent to the user confirming that the action, or no action, was acknowledged by the system and the requisite changes were made, if any.

While certain exemplary embodiments of the invention have been described and shown in the accompanying drawings, it is to be understood that such embodiments are merely illustrative of and not restrictive on the broad aspects of various embodiments of the invention, and that these embodiments not be limited to the specific constructions and arrangements shown and described, since various other modifications are possible.

What is claimed is:

1. A method comprising:
receiving a product identifier;
searching a database using the product identifier to uncover any occurrences of a product associated with the received product identifier; and
returning a message including a name of one or more merchants selling at least one of the product and an item equivalent to the product, a description of at least one of the product and the item equivalent to the product, and a price of at least one of the product and the item equivalent to the product.

2. The method of claim 1, wherein the image is a digital picture of a Uniform Product Code (UPC) number for the product.

3. The method of claim 1, wherein the image is a digital picture of a barcode of the product.

4. The method of claim 1, wherein the product identifier is a series of digits representing the product identifier

5. The method of claim 1, wherein the image is received from a digital camera in communication with a registry system that receives the image and recovers the product identifier from the image.

6. The method of claim 5, wherein the registry system includes a plurality of database servers collectively operating as the database.

7. The method of claim 1, wherein the product identifier is a value recovered from an image UPC Code or brand name/model number of the product or any other.

8. The method of claim 1, wherein the product identifier is a Uniform Product Code or brand name/model number of the product.

9. A method comprising:
receiving a product identifier downloaded from a portable electronic device;
reviewing a database by the portable electronic device using the product identifier to uncover any occurrences of a product associated with the product identifier; and
returning a message including a description of the product and a name of one or more merchants selling the product or an item equivalent to the product, and a price of the product or the item equivalent to the product.

10. The method of claim 9, wherein the product identifier is a Uniform Product Code (UPC) number recovered from an image being a digital image of the UPC number.

11. The method of claim 9, wherein the product identifier is a barcode recovered from an image being a digital image of the barcode.

12. The method of claim 9, wherein the product identifier is a Uniform Product Code (UPC) number.

13. The method of claim 9, wherein the product identifier is a description including a brand name and model number recovered from information downloaded from the portable electronic device.

14. The method of claim 10, wherein the image is received from a digital camera in communication with a registry system that receives the image and recovers the product identifier from the image.

15. The method of claim 14, wherein the registry system includes a plurality of database servers and a plurality of web servers.

16. A registry system comprising:
means for receiving a downloaded image;
means for recovering a product identifier from the image;
means for searching a database using the product identifier to uncover any occurrences of a product associated with the recovered product identifier; and
means for returning a message including a name of one or more merchants selling at least one of the product and an item equivalent to the product, and a price of at least one of the product and the item equivalent to the product.

17. The registry system of claim 16, wherein the means for returning further comprising means for returning a description of the product or the item equivalent to the product.

18. A method comprising:
receiving a product identifier;
searching a database using a received product identifier to uncover any occurrences of a product associated with the received product identifier; and
returning a message including a name of one or more merchants selling at least one of the product and an item equivalent to the product, a description of at least one of the product and the item equivalent to the product, and a price of at least one of the product and the item equivalent to the product;
selecting at least one of the product and the item equivalent to the product for uploading into the database.
